(19) United States
(12) Patent Application Publication
(10) Pub. No.: US 2015/0214718 A1
(43) Pub. Date: Jul. 30, 2015

(54) ELECTRICAL PROTECTION DEVICE

(71) Applicant: IEP2 RESEARCH PTY LIMITED, Newcastle, (AU)

(72) Inventors: Geoffrey Rubython, Mayfield (AU); Richard Harris, Karana Downs (AU)

(21) Appl. No.: 14/422,734

(22) PCT Filed: Aug. 22, 2013
(86) PCT No.: PCT/AU2013/000940

§ 371 Date: Feb. 20, 2015

(30) Foreign Application Priority Data
Aug. 22, 2012 (AU) 2012903629

(51) Int. Cl. H02H 3/10

(52) U.S. Cl. CPC H02H 3/10

(57) ABSTRACT

An electrical protection device for an electrical load includes a pair of input terminals and for respectively electrically connecting to an active conductor and a neutral conductor of an electrical power source. A pair of output terminals and electrically connects to load. A first monitoring unit is responsive to the load current flowing in conductors and for selectively generating a first fault signal. A second monitoring unit selectively generates a second fault signal. A protection unit operates in a normal state to electrically connect terminals and to terminals and respectively to allow the load current to flow from source to load via device. The unit is responsive to either of the first fault signal and the second fault signal for operating in a protected state to electrically isolate terminals and from terminals and, and prevent the flow of the load current.

### FIELD OF THE INVENTION

The present invention relates to an electrical protection device and to an electrical protection system including such a device.

Embodiments of the invention have been particularly developed for use in a low voltage electrical power distribution system (EDS) and in particular to mains voltage applications in residences, commercial premises and industrial sites. While some embodiments will be described herein with particular reference to those applications, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

EDSs come in many varied forms around the world. In Australia, for example, solid earthed environments are the norm (such as a TN-C-S arrangement). Alternatively, in certain applications and parts of the world, a fully isolated grounding system is preferred. This latter type of grounding system is referred to as an IT system and can support a single fault between the power conductors and ground without any immediate threat of injury or loss of service. A second fault must therefore occur before damage or risk to life occurs.

In other parts of the world like Japan use is made of a different system, referred to as a TT system. This is an arrangement where the earth paths for fault currents use actual earth grounds for conducting fault currents. These earth grounds can vary in impedance throughout their life from highly conducting to almost insulating. As a result this arrangement is partially or insecurely grounded.

Regardless of the type of EDS all require electrical protection between the power source and the load. Moreover, an EDS includes at least two conductors for allowing the load to draw load current from the source. Two essential conductors are usually referred to as the active conductor (or simply “active”) and the neutral conductor (or simply “neutral”) and these respectively provide for the flow of the load current from the source to the load, and for a return current from the load to the source. Both those currents will also flow through the electrical protection which is interposed between the source and the load.

In a typical conventional mains voltage installation in an earthed EDS the electrical protection is often provided by a residual-current device (known as an RCD). This technology was developed from the middle to the end of the last century as a method for providing secondary protection for an EDS. This form of protection is based upon a measurement of the difference between the input or load current (that is, the current flowing in the active conductor) and the return current (that is, the current flowing in the neutral conductor). It is usual for an electrical load (for example, an electrical circuit or electrical equipment) that is to be connected to the EDS to have protective metalwork—typically a protective housing. In an earthed EDS such as a TN-C-S system, the protective housing is connected to a separate electrical earth. That earth is also referenced to the power source. If a fault occurs in the electrical circuit or load which allows a fault current to flow through the metalwork to earth, this fault current will not return through the RCD and will be detected as an imbalance in RCD load and return currents. Once this imbalance exceeds a threshold the RCD instigates protective action.

The RCD protection has become ubiquitous in many countries as the dominant form of secondary safety protection. Even so, there are power distribution system arrangements and scenarios where current imbalance between active and neutral is a poor safety indicator. These include: isolated or high impedance earth power systems where little or no current flows until a second fault occurs (thus exposing users to unnecessary risk of harm); power generation faults where equal fault current flows in both the active and neutral conductors; and arrangements where faults currents vector to cancel at the point of the RCD even though at the fault site considerable fault current is flowing.

To effectively operate the RCD must be used in an earthed system. However, not all EDSs are earthed and, as such, other protection system have been developed for use in these non-earthed EDSs. For example, a separate protection technology—referred to as “the iFS technology”—was developed in the last two decades and has been disclosed in international patent application PCT/AU2009/001679 and international patent application PCT/AU2009/001678, the content of both of which is incorporated herein by way of cross reference. In summary this iFS technology operates by monitoring the protective metalwork of an electrical loads directly by sensing any fault current which flows from the metalwork to a reference conductor. Any current flow is typically caused by an elevation of mains potential of the metalwork as a result of a fault in the electrical insulation between the load and the protective metalwork. If the fault current from the load to the metalwork reaches a threshold level the iFS technology will institute a protective action.

As referred to above, the RCD technology only provides effective protection in properly earthed environments (power distribution systems with effective earth arrangements like TN-C-S systems—as are common place in Australia). It relies on the electrical continuity of the earthing arrangements to permit sufficient current flow during a fault to cause a measurable current unbalance at the RCD. The iFS technology, by comparison, does not depend on effective electrical earthing arrangements and any failure of insulation will cause a protection response. However, the iFS technology is defeated and/or desensitized in a well-earthed environment where the potential of the electrical metalwork is not significantly affected by the fault and therefore significant current will not flow through the reference conductor to cause a protective response.

All the existing systems have limitations and there is always a need in the art for an improved electrical protection device to improve safety and reduce damage caused to property from electrical malfunction.

### SUMMARY OF THE INVENTION

It is an object of the present invention to overcome or ameliorate at least one of the disadvantages of the prior art, or to provide a useful alternative.

It is an object of at least one of the embodiments to provide an improved electrical protection device to contribute to greater public safety and to reduce damage caused to property from electrical malfunction.

According to a first aspect of the invention there is provided an electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
a first monitoring unit that is responsive to the load current flowing in the active conductor and the neutral conductor for selectively generating a first fault signal;
a second monitoring unit for selectively generating a second fault signal in response to either or both of: current flowing from the surface; and the voltage between the surface and the neutral conductor and/or the earth; and
a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current.

In an embodiment the conductive surface is protective metalwork.

In an embodiment the protective metalwork defines an external housing for the load.

In an embodiment the first monitoring unit is responsive to an imbalance in the load current flowing in the active and the neutral conductors for selectively generating the first fault signal.

In an embodiment the first monitoring unit generates the first fault signal in response to the current imbalance exceeding a first predetermined threshold.

In an embodiment the second monitoring unit generates the second fault signal in response to the current flowing from the surface to the neutral conductor.

In an embodiment the second monitoring unit generates the second fault signal in response to the current flowing from the surface to the neutral conductor exceeding a second predetermined threshold.

In an embodiment the second monitoring unit generates the second fault signal in response to the current flowing from the surface to an earth.

In an embodiment the second monitoring unit generates the second fault signal in response to the current flowing from the surface to the earth exceeding a third predetermined threshold.

In an embodiment the second monitoring unit generates the second fault signal in response to the voltage between the surface and the neutral conductor.

In an embodiment the second monitoring unit generates the second fault signal in response to the voltage between the surface and the neutral conductor exceeding a fourth predetermined threshold.

In an embodiment the second monitoring unit generates the second fault signal in response to the voltage between the surface and the earth.

In an embodiment the second monitoring unit generates the second fault signal in response to the voltage between the surface and the earth exceeding a fifth predetermined threshold.

In an embodiment the electrical protection device includes a current limiter unit between the surface and an electrical earth, the current limiter unit being responsive to current flowing from the surface to the earth for selectively electrically isolating the surface from the earth. That is, the current limiter circuit prevents the flow of current from the surface to the earth.

In an embodiment, the protection unit is responsive to the current flowing from the surface to the earth for for operating in a protected state to electrically isolate the input terminals from the output terminals and prevent the flow of the load current.

In an embodiment the first monitoring unit includes a first electrical circuit and the second monitoring unit includes a second electrical circuit having at least one electrical component in common with the first electrical circuit.

In an embodiment the first electrical circuit and the second electrical circuit have multiple electrical components in common.

In an embodiment the at least one electrical component is a processor.

In an embodiment the at least one electrical component is a pair of mirrored processors.

In an embodiment the first monitoring unit and the second monitoring unit are defined by a single electrical circuit.

In an embodiment two or more of the first monitoring unit, the second monitoring unit, and the protection unit are defined by a single electrical circuit.

In an embodiment two or more of the first monitoring unit, the second monitoring unit, the current limiter unit, and the protection unit are defined by a single electrical circuit.

In an embodiment the single electrical circuit is contained within a single housing.

In an embodiment the single electrical circuit is mounted to a single circuit board.

In an embodiment the electrical protection device includes a plurality of electrical components, wherein substantially all the components are solid state components.

In an embodiment the electrical protection device includes a plurality of electrical components, wherein all of the electrical components are solid state components.

In an embodiment the solid state components are included in one or more integrated circuits.

In an embodiment the solid state components are included in a single integrated circuit.

In an embodiment at least one of the solid state components is formed using one of: Si technology; GaN technology; SiC technology; and MEMS technology.

In an embodiment the at least one solid state component is selected from: a transformer; and a mains voltage switching device.

In an embodiment the electrical protection device includes one or more processor.

In an embodiment the one or more processor includes one or more microprocessor.

In an embodiment the processor allows for testing of one or more functions of the device.

In an embodiment the testing is initiated by the processor.

In an embodiment the testing is initiated externally from the device.

In an embodiment the electrical protection device includes an alarm for indicating one or more states of the device.

In an embodiment the alarm indicates if one or more of the fault signals have been generated.

In an embodiment the alarm is one or more of: electrical; visual; and audible.

In an embodiment the electrical protection device includes a communications interface for allowing communication with a remote device.

In an embodiment the remote device is a controller and the protection device is a slave to that controller.

According to a second aspect of the invention there is provided an electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
at least one of:
i) a first monitoring unit that is responsive to the load current flowing in the active conductor and the neutral conductor for selectively generating a first fault signal; and
ii) a second monitoring unit for selectively generating a second fault signal in response to either or both of: current flowing from the surface to the neutral conductor; and the voltage between the surface and the neutral conductor; and
a protection unit for operating in a normal state to electrically connect the input terminals to the output terminals to allow the load current to flow from the source to the load via the protection device, the protection unit having at least one processor and being responsive to the fault signals for operating in a protected state to electrically isolate the input terminals from the output terminals and prevent the flow of the load current.

In an embodiment the protection device includes a current limiter unit between the surface and an electrical earth, the current limiter unit being responsive to current flowing from the surface to the earth for selectively electrically isolating the surface from the earth.

According to a third aspect of the invention there is provided an electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
a first monitoring unit having a first electrical circuit that is responsive to the load current flowing in the active conductor and the neutral conductor for selectively generating a first fault signal;
a second monitoring unit having a second electrical circuit for selectively generating a second fault signal in response to either or both of: current flowing from the surface to the neutral conductor; and the voltage between the surface and the neutral conductor; and
a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current, wherein the first electrical circuit and the second electrical circuit include at least one common electrical component.

In an embodiment the first electrical circuit and the second electrical circuit include multiple common electrical components.

In an embodiment the at least one common electrical device includes a processor.

In an embodiment the first electrical circuit and the second electrical circuit include a common circuit board.

In an embodiment the protection device includes a current limiter unit between the surface and an electrical earth, the current limiter unit being responsive to current flowing from the surface to the earth for selectively electrically isolating the surface from the earth.

According to a fourth aspect of the invention there is provided an electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
a first monitoring unit for selectively generating a first fault signal;
a current limiter unit between the surface and an electrical earth, the current limiter unit being responsive to current flowing from the surface to the earth for selectively electrically isolating the surface from the earth; and
a protection unit for operating in a normal state to electrically connect the input terminals to the output terminals to allow the load current to flow from the source to the load via the protection device, the protection unit being responsive to the first fault signal for operating in a protected state to electrically isolate the input terminals from the output terminals and prevent the flow of the load current.

In an embodiment the first monitoring unit is responsive to the load current flowing in the active conductor and the neutral conductor for selectively generating the first fault signal.

In an embodiment the protection device includes a second monitoring unit for selectively generating a second fault signal, wherein: the protection unit is responsive to the second fault signal for operating in a protected state to electrically isolate the input terminals from the output terminals and prevent the flow of the load current; and the second fault signal is generated in response to either or both of: current flowing from the surface to the neutral conductor; and the voltage between the surface and the neutral conductor.

According to a fifth aspect of the invention there is provided an electrical protection device including:
at least two input terminals for electrically connecting to an active conductor and a neutral conductor of an electrical power source that is upstream of the protection device;
at least two output terminals for electrically connecting to a load that is downstream of the protection device;
a monitoring unit that is responsive to current flowing through at least one of the input terminals and/or at least one of the output terminals for selectively generating a first fault signal;
a current limiter that is responsive to the first fault signal for limiting to a predetermined current threshold a current flowing from the source to the load or from the load to an earth;
a protection unit for operating in a normal state to connect the input terminals to the output terminals to allow current to flow from the source to the load via the protection device, the protection unit being responsive to a second fault signal for operating in a protected state to disconnect the input terminals from the output terminals and prevent the flow;
a fault detection unit that is responsive to at least a current imbalance between the active conductor and the neutral conductor for selectively generating the second fault signal; and
a downstream detection unit that is responsive to a current downstream of the device for selectively generating the second fault signal.

In an embodiment the first fault signal will be generated before the second fault signal.

In an embodiment the monitoring unit includes a microprocessor.

In an embodiment the load includes a chassis.

In an embodiment the current imbalance between the active conductor and the neutral conductor is less than about 30 mA.

In an embodiment the current imbalance between the active conductor and the neutral conductor is less than about 20 mA.

In an embodiment the current imbalance between the active conductor and the neutral conductor is less than about 10 mA.

In an embodiment the device will sense a current imbalance, generate a fault signal and limit the current in less than about 10 ms.

In an embodiment the device will sense a current imbalance, generate a fault signal and limit the current in less than about 8 ms.

In an embodiment the device will sense a current imbalance, generate a fault signal and disconnect the input terminals from the output terminals in less than about 10 ms.

In an embodiment the device will sense a current imbalance, generate a fault signal and disconnect the input terminals from the output terminals in less than about 8 ms.

In an embodiment the predetermined current threshold is about 5 mA.

In an embodiment the predetermined current threshold is about 8 mA.

In an embodiment the predetermined current threshold is about 10 mA.

According to a sixth aspect of the invention there is provided an electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
a first monitoring unit that is responsive to the load current flowing in the active conductor and the neutral conductor for selectively generating a first fault signal;
a second monitoring unit for selectively generating a second fault signal in response to both of: current flowing from the surface; and the voltage between the surface and the neutral conductor and/or the earth; and
a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current.

According to a seventh aspect of the invention there is provided an electrical protection system including one or more of electrical protection devices defined in any one or more of the preceding aspects of the invention described above.

According to an eighth aspect of the invention there is provided an electrical distribution system including one or more of electrical protection devices defined in any one or more of the first to the sixth aspects described above.

According to a ninth aspect of the invention there is provided a method for providing electrical protection for an electrical load having an external conductive surface, the method including:
electrically connecting at least two input terminals to an active conductor and a neutral conductor of an electrical power source that is upstream of the terminals;
electrically connecting at least two output terminals to the load, wherein the load is electrically downstream of the output terminals and, in use, draws a load current;
being responsive to the load current flowing in the active conductor and the neutral conductor for selectively generating a first fault signal;
selectively generating a second fault signal in response to either or both of: current flowing from the surface; and the voltage between the surface and the neutral conductor and/or the earth; and
providing a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current.

According to a tenth aspect of the invention there is provided a method for providing electrical protection for an electrical load having an external conductive surface, the method including:
electrically connecting at least two input terminals to an active conductor and a neutral conductor of an electrical power source that is upstream of the terminals;
electrically connecting at least two output terminals to the load, wherein the load is electrically downstream of the output terminals and, in use, draws a load current;
providing at least one of:
i) a first monitoring unit that is responsive to the load current flowing in the active conductor and the neutral conductor for selectively generating a first fault signal; and
ii) a second monitoring unit for selectively generating a second fault signal in response to either or both of: current flowing from the surface to the neutral conductor; and the voltage between the surface and the neutral conductor; and
providing a protection unit for operating in a normal state to electrically connect the input terminals to the output terminals to allow the load current to flow from the source to the load via the protection device, the protection unit having at least one processor and being responsive to the fault signals for operating in a protected state to electrically isolate the input terminals from the output terminals and prevent the flow of the load current.

According to a eleventh aspect of the invention there is provided a method of providing electrical protection for an electrical load having an external conductive surface, the method including:
electrically connecting at least two input terminals to an active conductor and a neutral conductor of an electrical power source that is upstream of the terminals;
electrically connecting at least two output terminals to the load, wherein the load is electrically downstream of the output terminals and, in use, draws a load current;
providing a first monitoring unit having a first electrical circuit that is responsive to the load current flowing in the active conductor and the neutral conductor for selectively generating a first fault signal;
providing a second monitoring unit having a second electrical circuit for selectively generating a second fault signal in response to either or both of: current flowing from the surface to the neutral conductor; and the voltage between the surface and the neutral conductor; and
providing a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current, wherein the first electrical circuit and the second electrical circuit include at least one common electrical component.

According to a twelfth aspect of the invention there is provided a method for providing electrical protection for an electrical load having an external conductive surface, the method including:
electrically connecting at least two input terminals to an active conductor and a neutral conductor of an electrical power source that is upstream of the terminals;
electrically connecting at least two output terminals to the load, wherein the load is electrically downstream of the output terminals and, in use, draws a load current;
selectively generating a first fault signal;
providing a current limiter unit between the surface and an electrical earth, the current limiter unit being responsive to current flowing from the surface to the earth for selectively electrically isolating the surface from the earth; and
providing a protection unit for operating in a normal state to electrically connect the input terminals to the output terminals to allow the load current to flow from the source to the load via the protection device, the protection unit being responsive to the first fault signal for operating in a protected state to electrically isolate the input terminals from the output terminals and prevent the flow of the load current.

According to a thirteenth aspect of the invention there is provided a method for providing electrical protection, the method including:
electrically connecting at least two input terminals to an active conductor and a neutral conductor of an electrical power source that is upstream of the terminals;
electrically connecting at least two output terminals to a load that is downstream of the output terminals;
being responsive to current flowing through at least one of the input terminals and/or at least one of the output terminals for selectively generating a first fault signal;
being responsive to the first fault signal for limiting to a predetermined current threshold a current flowing from the source to the load or from the load to an earth;
providing a protection unit for operating in a normal state to connect the input terminals to the output terminals to allow current to flow from the source to the load via the protection device, the protection unit being responsive to a second fault signal for operating in a protected state to disconnect the input terminals from the output terminals and prevent the flow;
being responsive to at least a current imbalance between the active conductor and the neutral conductor for selectively generating the second fault signal; and
being responsive to a current downstream of the output terminals for selectively generating the second fault signal.

According to a fourteenth aspect of the invention there is provided a method of providing electrical protection for an electrical load having an external conductive surface, the method including:
electrically connecting at least two input terminals to an active conductor and a neutral conductor of an electrical power source that is upstream of the terminals;
electrically connecting at least two output terminals to the load, wherein the load is electrically downstream of the output terminals and, in use, draws a load current;
being responsive to the load current flowing in the active conductor and the neutral conductor for selectively generating a first fault signal;
selectively generating a second fault signal in response to both of: current flowing from the surface; and the voltage between the surface and the neutral conductor and/or the earth; and
providing a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current.

According to a fifteenth aspect of the invention there is provided a method of providing electrical protection, the method including: selecting one or more of electrical protection devices defined in any one or more of the preceding aspects of the invention described above; disposing the electrical protection devices electrically between an electrical source and at least one electrical load.

According to a sixteenth aspect of the invention there is provided an electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
a first monitoring unit that is responsive to the load current flowing in the active conductor and the neutral conductor for selectively generating a first fault signal;
a second monitoring unit for selectively generating a second fault signal in response to either or both of: current flowing from the surface; and the voltage between the surface and the neutral conductor and/or an earth; and
a protection unit for operating in a normal state to electrically connect the input terminals to the output terminals to allow the load current to flow from the source to the load via the protection device, the protection unit being responsive to the fault signals for operating in a protected state to electrically isolate the input terminals from the output terminals and prevent the flow of the load current, wherein the protection unit and one or more of the first monitoring unit and the second monitoring unit are integrated.

In an embodiment the protection unit and both of the first monitoring unit and the second monitoring unit are integrated.

According to a seventeenth aspect of the invention there is provided a method of providing electrical protection for an electrical load having an external conductive surface, the method including:
electrically connecting at least two input terminals to an active conductor and a neutral conductor of an electrical power source that is upstream of the terminals;
electrically connecting at least two output terminals to the load, wherein the load is electrically downstream of the output terminals and, in use, draws a load current;
being responsive with a first monitoring unit to the load current flowing in the active conductor and the neutral conductor for selectively generating a first fault signal;
selectively generating with a second monitoring unit a second fault signal in response to either or both of: current flowing from the surface; and the voltage between the surface and the neutral conductor and/or an earth; and
providing a protection unit for operating in a normal state to electrically connect the input terminals to the output terminals to allow the load current to flow from the source to the load via the protection device, the protection unit being responsive to the fault signals for operating in a protected state to electrically isolate the input terminals from the output terminals and prevent the flow of the load current, wherein the protection unit and one or more of the first monitoring unit and the second monitoring unit are integrated.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of” or “which comprises” is an open term that means “including at least the elements/features that follow, but not excluding others”. Thus, the term “comprising”, when used in the claims, should not be interpreted as being limitative to the means or elements or steps listed thereafter. For example, the scope of the expression “a device comprising A and B” should not be limited to devices consisting only of elements A and B. Any one of the terms “including” or “which includes” or “that includes” as used herein is also an open term that also means “including at least the elements/features that follow the term, but not excluding others”. Thus, “including” is synonymous with and means “comprising”.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 is a schematic representation of an electrical protection device according to one embodiment, shown in the protected state;

FIG. 2 is a schematic representation of the device of FIG. 1 in normal state;

FIG. 3 is schematic representation of a protection device according to another embodiment illustrating the load being electrically isolated from the source;

FIG. 4 is a schematic representation of the device of FIG. 3 illustrating the load being electrically connected to the source;

FIG. 5 is circuit diagram for the electrical components included within the protection device of FIG. 3 with bounded areas to illustrate the shared components;

FIG. 6 is the circuit diagram of FIG. 5 omitting the bounded areas; and

FIG. 7 is a flowchart illustrating the operation of the device of FIG. 3.

### DETAILED DESCRIPTION

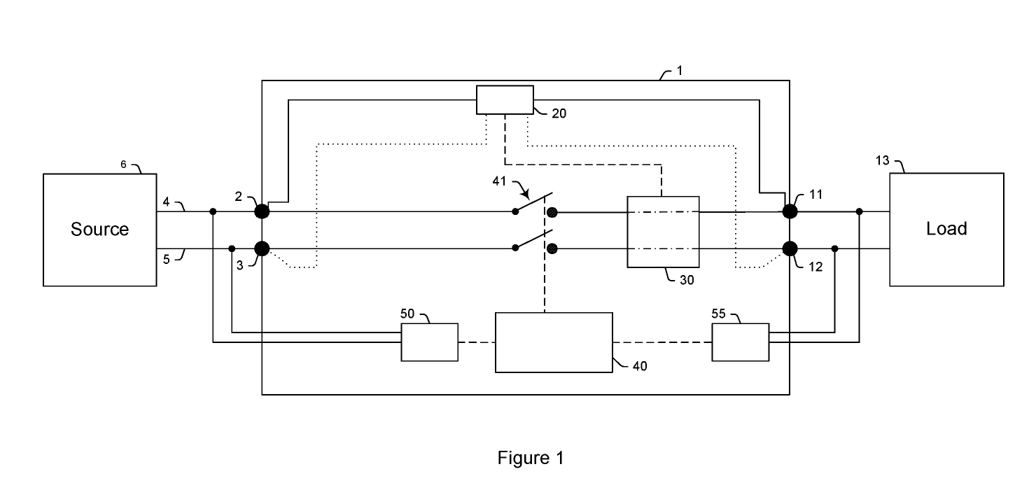

Referring to FIG. 1, there is shown a first embodiment, which includes an electrical protection device 1. Device 1 is referred to by the applicant as a Super Residual Current Device (Super RCD). Device 1 includes two input terminals 2 and 3 for respectively electrically connecting to an active conductor 4 and a neutral conductor 5 of an electrical power source 6 that is upstream of device 1. Also included in device 1 are two output terminals 11 and 12 for electrically connecting to a load 13 that is downstream of device 1.

A monitoring unit in the form of a microprocessor 20 is responsive to current flowing through input terminal 2 and output terminal 11 for selectively generating a first fault signal. In other embodiments, microprocessor 20 is responsive to current flowing through input terminal 3 and output terminal 12. In yet other embodiments, microprocessor 20 is responsive to current flowing through input terminal 2 and output terminal 12. In yet other embodiments, microprocessor 20 is responsive to current flowing through input terminal 3 and output terminal 11.

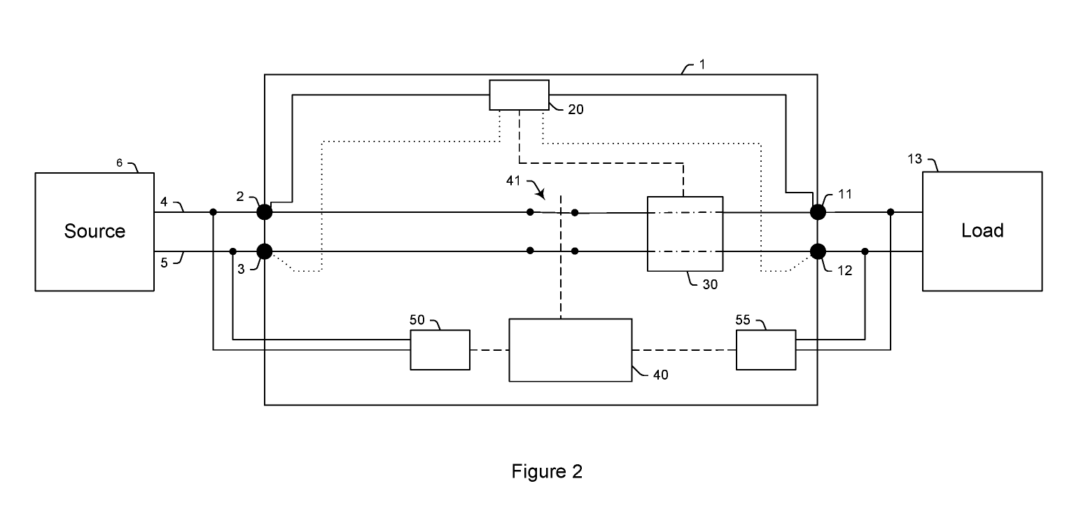

Device 1 includes a current limiter 30 that is responsive to the first fault signal for limiting current flow from source 6 to the load 13 to a predetermined current threshold. A protection unit 40 for operating in a normal state (shown in FIG. 2) connects input terminals 2 and 3 to output terminals 11 and 12 to allow current to flow from source 6 to load 13 via device 1. Protection unit 40 is responsive to a second fault signal for operating in a protected state (shown in FIG. 1) to disconnect input terminals 2 and 3 from output terminals 11 and 12 via a relay 41 and prevent the current flow.

Also included in device 1 is a fault detection unit 50 that is responsive to at least a current imbalance between active conductor 4 and neutral conductor 5 for selectively generating the second fault signal. This functionality that is provided in part by unit 50 is referred to as the RCD functionality.

Furthermore, device 1 includes a downstream detection unit 55 that is responsive to a current downstream of device 1 for selectively generating the second fault signal.

The predetermined current threshold from which the first fault signal is responsive, is about 5 mA. In another embodiment, the predetermined current threshold is about 8 mA. In yet another embodiment, the predetermined current threshold is about 10 mA.

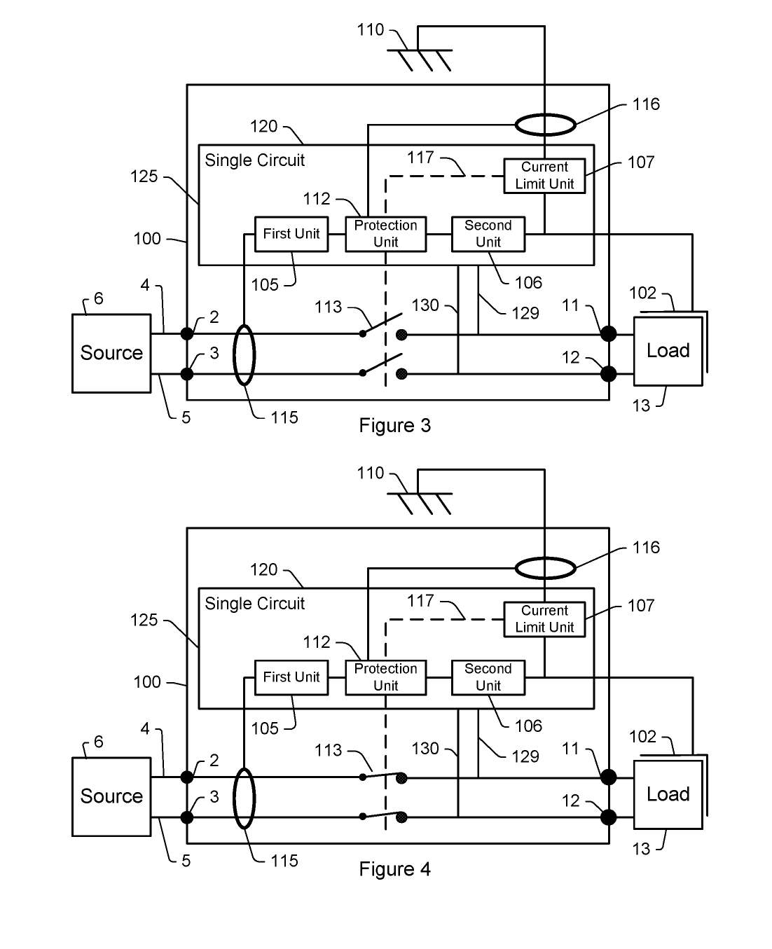

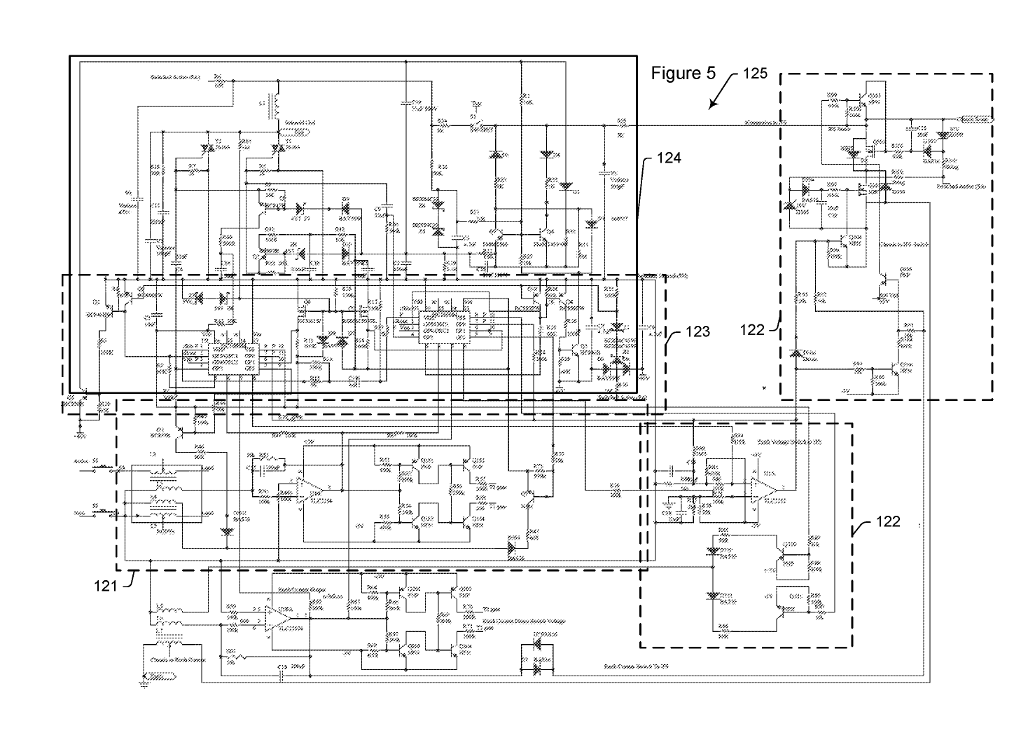

Load 13 includes a chassis (not shown), which essentially denotes a component on the load which a user can come into contact and possibly be electrocuted by this contact. The chassis, in various embodiments, includes: a frame, housing, and support, to name but a few. The chassis is also referred to as the protective metalwork for the load and is used by device 1 (not shown in FIGS. 1 and 2) as a reference point for a voltage and/or a current measurement between the chassis and one or more of conductors 2 and 3 and/or to an earth point. This occurs to allow the implementation of iFS-style functionality (simply referred in this specification as “iFS functionality”) as well as earth isolation functionality. These two functionalities are provided for in the circuit illustrated in FIG. 5, and is described in more detail below with reference to the embodiment of FIGS. 3 and 4.

Generally, the first fault signal will be generated before the second fault signal. Accordingly, in the event of a fault, the limiting of the current will occur before the disconnection of the source from the load. This will allow for the load to continue to be powered, when it is safe to do so.

In other embodiments, the second fault signal occurs before the first fault signal. This embodiment utilizes the current limiter as a back-up safety mechanism. In the event of malfunction of the device where a second fault signal is generated but fault detection unit 50 and downstream detection unit 55 do not electrically disconnect the source from the load, the first fault signal will be generated and the current limiter will limit the current.

In yet other embodiments, the first fault signal and the second fault signal are generated independently of one another and, therefore, will not be generated in a consistent order.

The current imbalance between the active conductor and the neutral conductor that will cause a second fault signal to be generated is about 30 mA. In more preferable embodiments, the current imbalance between conductor 4 and conductor 5 is less than about 30 mA. More preferably, the current imbalance between conductor 4 and conductor 5 is less than about 20 mA. Even more preferably, the current imbalance between conductor 4 and 5 is less than about 10 mA.

Microprocessor 20 is responsive to an imbalance in upstream current flowing through terminal 2 and downstream current flowing though terminal 11. The current imbalance between the upstream current and the downstream current that will cause the first fault signal to be generated is less than about 30 mA. More preferably, the current imbalance between the upstream current and the downstream current is less than about 20 mA to cause the generation of the first fault signal. Even more preferably, the current imbalance between the upstream current and the downstream current is less than about 10 mA.

Device 1 is configured to sense a current above a predetermined threshold in either of the upstream and downstream currents, and to generate the first fault signal and limit the current to that threshold in less than about 10 ms. More preferably, device 1 will carry out this sequence of actions to limit the current in less than about 8 ms.

Device 1 is also configured to sense a current imbalance (either between conductor 4 and 5 or downstream of device 1), generate the second fault signal and disconnect input terminals 2 and 3 from the output terminals 11 and 12 in less than about 10 ms. More preferably, device 1 will carry out this sequence of actions to disconnect input terminals 2 and 3 from the output terminals 11 and 12 in less than about 8 ms.

The Super RCD, in embodiments, is also capable of monitoring more than two points of reference at once and can monitor multiple points simultaneously. For example, the active, neutral and earth conductors from a number of power sources can be monitored by the same Super RCD simultaneously along with monitoring a number of loads at different reference points. This provides the Super RCD with additional information which is used to provide status information about the electrical environment and the various components. The Super RCD will use this information to note situations of danger as well as to generally provide intelligence on the operation of the environment. This can assist in the optimal electrical powering of a load or number of loads from one or more power sources.

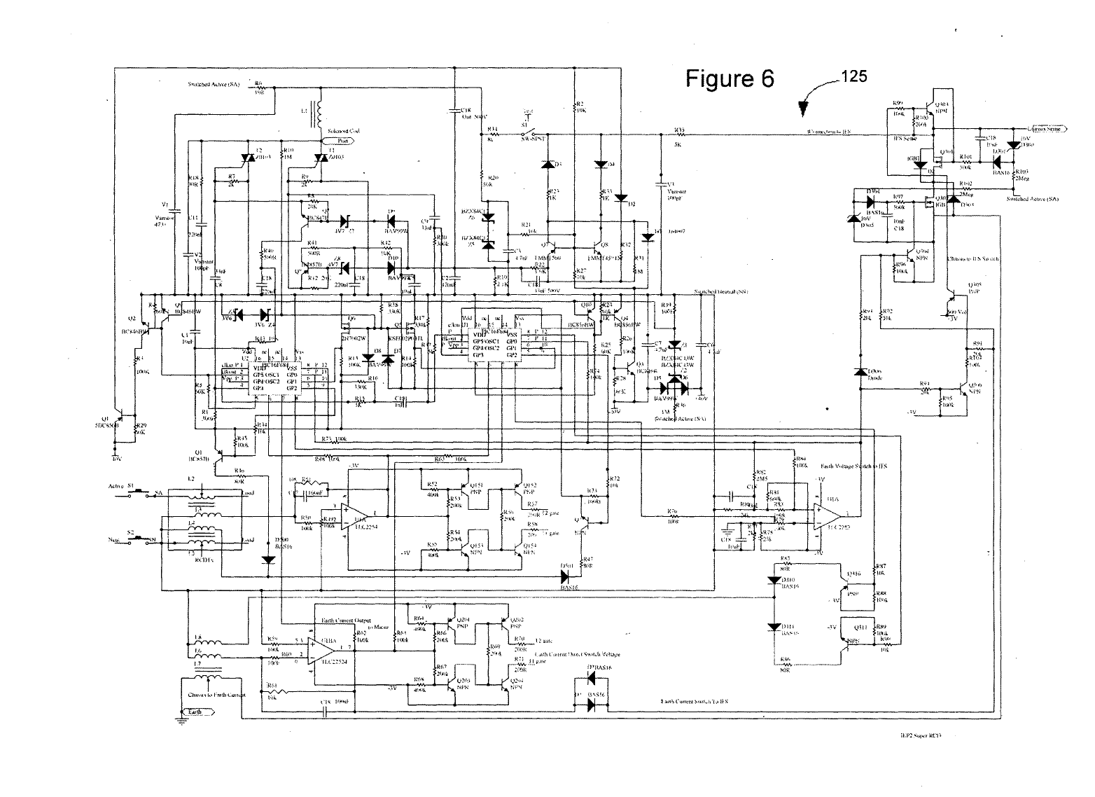

To better illustrate the iFS functionality and other functionality reference is now made to a further embodiment of the Super RCD that is illustrated in FIGS. 3 to 6. The major objectives of the design of this further embodiment were as follows:
Add an improved RCD function to the “iFS” isolation design technology where there may be earthed systems present.
Provide safety and supply continuity where nominally earthed systems develop a high Earth resistance to Neutral.
Utilize the iFS style of current limiting capability (under 10 mA) to further enhance personnel safety and equipment protection.
Provide Earth Current measurement to further understand origin and direction of leakage currents so that the most comprehensive and safe. Power removal or current limiting action can be taken.
Provide as fail safe a system as possible by automatically and regularly testing all functions, by providing circuit redundancy and avoiding microprocessor involvement in critical “turn off” or “current limiting” decisions.
Meet high volume cost objectives by using the most appropriate components, design and manufacturing processes.

All of the above features are, or are also able to be, implemented in different embodiments of device 1.

The broad principles of the functions of the preferred embodiments, and particularly of this further embodiment are:
The iFS function of operation and current limiting are maintained giving a fast 5 mA triggering sensitivity and under 10 mA current limiting to the chassis of the equipment being protected. Minor improvements have been made to the triggering sensitivity calibration and circuitry to improve consistency and reduce cost.
The RCD function uses a classical torroid load Active and Neutral differential current sensing with accurate amplification and triggering using an operational amplifier. A standard torroid has been chosen for this component in this embodiment. The RCD function is set at 30 mA typically, although that will depend on the MCB rating chosen.
The Earth Current measurement function is initially established using a high current transistor switch that is “normally on” to give a low earth to chassis resistance in the normally operating mode. This high current switch will be turned “off” when the earth current reaches a yet to be decided level and the MCB power will be turned “off” when the earth current reaches 30 mA. When the transistor switch turns “off” the Super RCD becomes a current limiting iFS triggering at 5 mA and limiting the current during and after triggering.
The Earth current measurement uses a similar torroid to the RCD torriod and a similar amplification and triggering circuitry. The MCB triggering current is 30 mA and it has the addition of an optional automatic lower level “switching off” of the transistor earthing switch to current limiting.
The microprocessors monitor both the RCD Differential Current and the Earth Current which will match for a simple leakage of the machine to earth (or an operator receiving an electric shock between the machine active and the machine chassis). When the currents do not match due to machine “active” leakage (or more likely an electric shock) to a different chassis (low earth current), between a different chassis and the machine earth (low RCD current) or due to earth currents creating electric shocks, the microprocessors initiate early “power removal” or early transistor “switch to current limit” decisions to protect operators and reduce equipment damage. Note that the microprocessors are operating in a “fail safe” manner toward an early power removal or current limit rather than waiting until the “machine set” limits are reached.
All of the above measurement and MCB triggering systems are intended to be much faster than standard that provided by a conventional RCDs with the additional benefit of ruggedness relating to transients in the systems being measured.

The broad testing regime of the iFS functionality has resulted in the use of two triacs, microprocessors and circuitry sets, one “set” for each half cycle.

There is only one op-amp for each of the RCDs, Earth to Neutral current and Earth Resistance measurements but there is already duplication between RCD, Earth Current and “switched to IFS” functions that are able to be exploited prior to system shut down when a fault possibility has been discovered. Due to the increased “demand” on the microprocessors for testing and monitoring lower power microprocessors have been selected with more pin outs.

For the iFS function, testing functionality has been retained.

The RCD function is tested by running a transient 30 mA current through the iFS torroid near zero cross and observing triac triggering for each half cycle.

The Earth Current triggering is similarly measured by applying a 30 mA current pulse in the earth current torroid and observing the triacs triggering the MCB.

The earth to neutral resistance monitor is tested for each half cycle to confirm the earth “switch to current limit” function is working as well as confirming the earth resistance monitoring and switching to iFS is within specifications.

The design of the further embodiment has many features both in performance and safety that provide a new benchmark in safety switching. In addition there is the potential and flexibility within the design for further enhancement on the performance side to accommodate specific industry needs without compromising safety switching protection.

The preferred embodiments provide a safety switch that includes the benefits of RCD technology in the presence of earthed systems and yet provides the speed and chassis (earth pin) current limiting of an iFS safety switch for improved safety and equipment protection.

The basic function of the Super RCD is based around three measurement and triggering functions:
Differential current measurement (RCD type) with Circuit Breaker turn off set to 30 mA.
Chassis to Earth current measurement with Circuit Breaker turn off set to 30 mA and Chassis to Neutral Switch, Current Limit and Circuit Breaker turn off set to 10 mA.

Dual measurement and circuit breaker triggering components provide redundant circuitry while dual microprocessors provide self monitoring and self testing functions with automatic circuit breaker triggering should a fault exist. Should the circuit breaker weld shut the current limit capability will allow an operator to “let go” of the wires or chassis that is causing an electric shock.

Some performance and safety features of the Super RCD are considerable, and are centred upon reducing the risk of injury to humans that are exposed to a fault, and reducing the risk of damage to associated equipment and property. These safety features include, by way of example:
Triggering the Circuit Breaker within 5 ms to 10 ms.
Limiting electric shock and leakage current to 10 mA.
Detecting and providing safety in high impedance Earth to Neutral (fault or location) environments.
Recognizing and acting on the three possible electric shock (or fault leakage) events. These events include:
   Active to chassis shock or leakage within the same circuit breaker loop (RCD measurement plus chassis current measurement and limiting).
   Active of a different Circuit Breaker loop to the chassis of the same circuit breaker loop shock or leakage (chassis current measurement and limiting. RCD is not functional).
   Active of the same circuit breaker loop to the chassis of a different circuit breaker loop shock or leakage (RCD Measurement).

In any electrical circuit with an Active and a Neutral the current flow is from Active to Neutral. The introduction of Earth or Ground and the subsequent connection of Neutral to Ground in various countries and locations have some variations in regulations. The apparent reliance on “Earth” from a safety viewpoint has been largely misunderstood. By way of example, since the plumbing systems have increasingly moved from the use of copper pipes to plastic pipes (for cost reasons) electrical safety in the home has been decreased as the reliance on a common earth is less certain.

Isolated systems (from Ground) have been shown to offer the maximum safety.

The development of RCD safety switches has improved safety only where the Ground to Neutral connection has been well maintained. There are regions in Australia as well as elsewhere in the world where a good Ground to Neutral connection is not present and the use of RCDs to provide adequate protection is problematic. This is of course not a loop wiring issue but often a “wiring to the pole” and/or a “dry” earth stake depending on location and regulation around the world.

Ultimately leakage currents go to Neutral at the power source (switchboard, power pole or transformer station).

For those applications making use of the Super RCD, when a high Earth current is detected there is an electronic switch that releases the Earth wire from Ground and references it to Neutral in a current measurement and current limiting circuit with a fast response time. This low current limit of 10 mA provides the added safety that allows a person suffering an electric shock to release the wire/chassis/item they are holding and connecting to the chassis. Depending on the resistance of the shock or leakage to the chassis the chassis voltage rises to limit the current this is less than 40 Volts for a 10 mA leakage or high skin resistance shock to full mains voltage for an active to earth short circuit.

In the most cost-effective version of this electronic switch the electronic components are fast, rated for the mains voltage, and high transient current switches. Recognizing that the switching will be occurring at the 10 mA current limiting level sensed by the Earth current sensor there is only a transient requirement for very high currents.

In this most cost-effective solution the electronic switches are “normally off” meaning a supply voltage (at very low current) is required to turn them “on” and create the Earth to Chassis link. Thus any testing of chassis earths requires the Super RCD to be in place and have an active supply connected to it.

It is noted that the Super RCD protects from the supply source with RCD technology by turning off the supply when the active/neutral current differential exceeds 30 mA and also protects at the leakage to chassis end by limiting the current to 10 mA (and switching off the supply if matched by RCD differential current) at the same time. This has a significant benefit in ground current created electric shock situations.

A high level outline of the functionality provided by the Super RCD is provided in Table 1 of Australian provisional patent application 2012903629 filed 22 Aug. 2012, the subject matter of which is incorporated herein in its entirety by way of cross reference.

For the purpose of clarifying the basic unique operational characteristics arising from the integration of the iFS technology with the RCD technology and, the benefits of the Super RCD, exemplary performance criteria is provided in Table 2 of Australian provisional patent application 2012903629 filed 22 Aug. 2012, the subject matter of which is incorporated herein in its entirety by way of cross reference.

Important to the practical development of the Super RCD is compliance with international standards for isolation in response to the full spectrum of fault conditions defined for the RCD. The nature of the protection performance provided by the Super RCD is provided in Table 3 of Australian provisional patent application 2012903629 filed 22 Aug. 2012, the subject matter of which is incorporated herein in its entirety by way of cross reference.

Installation circuits, equipment and environments present a spectrum of operational challenges. Standard and regulations mandate compatibility with a range of devices and installation configurations and the need to continue operation. The continuance of operation performance of an embodiment of the Super RCD is provided in Table 4 of Australian provisional patent application 2012903629 filed 22 Aug. 2012, the subject matter of which is incorporated herein in its entirety by way of cross reference.

In other embodiments, the RCD functionality is substituted with the functionality of one or more of: an RCCG; and a RCBO. That is, the iFS functionality—in some cases together with a selected one or more of the other functionalities such as the earth isolation functionality, the testing functionality, and other functionalities of the above embodiments—is able to be applied to other protection devices and not simply to an RCD-type protection device. The present applicant designates embodiments of the invention having the RCCG functionality as “Super RCCB”, and embodiments having the RCBO functionality as “Super RCBO”.

There are three international earthing systems. Most countries now operate a mix of TN and TT. In manufacturing buildings the installation of all three systems is not uncommon in all main international markets. Consequently, the Super RCD/Super RCCG/Super RCBO is configured from the start to be able to operate or be easily adapted to operate with all current RCD configurations as a “plug and play” without variations to the installation procedure other than those mandated for the installation of RCDs in each of the three international earthing systems. The compatibility of the Super RCD to the different earthing systems is provided in Table 5 of Australian provisional patent application 2012903629 filed 22 Aug. 2012, the subject matter of which is incorporated herein in its entirety by way of cross reference.

The Super RCD has been designed for use with many different installations that are presently configured for different RCDs. Examples of these are provided in Table 6 of Australian provisional patent application 2012903629 filed 22 Aug. 2012, the subject matter of which is incorporated herein in its entirety by way of cross reference.

Other device requirements and design features for the Super RCD are provided in Table 7 of Australian provisional patent application 2012903629 filed 22 Aug. 2012, the subject matter of which is incorporated herein in its entirety by way of cross reference.

Selected desired features for other preferred embodiments of the Super RCD are provided in Table 8 of Australian provisional patent application 2012903629 filed 22 Aug. 2012, the subject matter of which is incorporated herein in its entirety by way of cross reference.

Selected performance, rating and feature requirements for embodiments of the Super RCD are provided in Table 9 of Australian provisional patent application 2012903629 filed 22 Aug. 2012, the subject matter of which is incorporated herein in its entirety by way of cross reference.

The ability of the Super RCD to be configured for compliance with standards and regulations (such as the Cenelec and IEC Standards) is provided in Table 10 of Australian provisional patent application 2012903629 filed 22 Aug. 2012, the subject matter of which is incorporated herein in its entirety by way of cross reference.

The electrical components used in device 1, and the arrangement and connection of those components, is shown in detail in FIG. 3 of Australian provisional patent application 2012903629 filed 22 Aug. 2012, the subject matter of which is incorporated herein in its entirety by way of cross reference. Moreover, the specific components are listed in Tables 11 to 15 inclusive of Australian provisional patent application 2012903629 filed 22 Aug. 2012, the combined subject matter of which is incorporated herein in its entirety by way of cross reference.

The further embodiment of the Super RCD is illustrated specifically in FIGS. 3 and 4. More particularly, there is shown an electrical protection device 100 for an electrical load 13 having an external conductive surface in the form of protective metalwork 102. Device 100 includes a pair of input terminals 2 and 3 for respectively electrically connecting to an active conductor 4 and a neutral conductor 5 of an electrical power source 6 that is upstream of device 100. A pair of output terminals 11 and 12 electrically connects to load 13. The load is electrically downstream of device 100 and, in use, draws a load current. A first monitoring unit 105 is responsive to the load current flowing in conductors 4 and 5 for selectively generating a first fault signal. A second monitoring unit 106 selectively generates a second fault signal in response to current flowing from metalwork 102 to conductor 5. A current limiter unit 107 is disposed electrically between metalwork 102 and an electrical earth 110. Unit 107 is responsive to current flowing from metalwork 102 to earth 110 for selectively electrically isolating the metalwork from earth 110. A protection unit 112 operates in a normal state to electrically connect terminals 2 and 3 to terminals 11 and 12 respectively (as shown in FIG. 4) to allow the load current to flow from source 6 to load 13 via device 1. Unit 112 is responsive to either of the first fault signal and the second fault signal for operating in a protected state (as shown in FIG. 3) to electrically isolate terminals 2 and 3 from terminals 11 and 12, and prevent the flow of the load current. The latter occurs in this embodiment by unit 112 progressing a single throw double pole switch 113 from a closed configuration shown in FIG. 4 to an open configuration shown in FIG. 3.

For device 100: the RCD functionality is provided by unit 105 in combination with unit 112; the iFS functionality is provided by unit 106 in combination with unit 112; and the earth isolation functionality is provided by unit 107 in combination with unit 112.

In this exemplary embodiment load 13 is a refrigerator for use in a retail supermarket and the protective metalwork 102 defines an external housing for the refrigerator that is able to be contacted by customers of the supermarket as they access goods from within the refrigerator. It will be appreciated that in other embodiments load 13 is other than an electrical appliance, and is another form of electrical load.

Monitoring unit 105 includes a differential transformer 115 and is responsive to an imbalance in the load current flowing downstream of the device in conductors 4 and 5 for selectively generating the first fault signal. More particularly, in this embodiment unit 105 generates the first fault signal in response to the current imbalance exceeding a first predetermined threshold of 30 mA. However, in other embodiments the threshold is other than 30 mA. In other exemplary embodiments the threshold is one of: 50 mA; 15 mA; 20 mA; or another value selected for the specific application.

Monitoring unit 106 generates the second fault signal in response to the current flowing from metalwork 102 to conductor 5 exceeding a second predetermined threshold of 30 mA. However, in other embodiments the threshold is other than 30 mA. In other exemplary embodiments the threshold is one of: 50 mA; 15 mA; 20 mA; or another value selected for the specific application.

In other embodiments unit 106 generates the second fault signal in response to the voltage between the surface and the neutral conductor exceeding a third predetermined threshold of 5 Volts. In other embodiments different voltage thresholds are used.

In further embodiments unit 106 generates the second fault signal in response to both of: current flowing from metalwork 102 to conductor 5; and the voltage between metalwork 102 and conductor 5. That is, either of the two conditions, if present, will result in the second fault signal being generated, whereas in the earlier described embodiments only one of the two conditions is monitored.

Unit 112 includes a transformer 116 for providing a signal indicative of the current flowing from metalwork 102 to earth 110. The unit 112 is responsive to that signal for providing a control signal in control line 117 that actuates unit 107 to electrically isolate metalwork 102 from earth 110. Unit 112 is responsive to the signal indicating that the current flowing is greater than a fourth predetermined threshold. In this particular embodiment the predetermined threshold is 5 mA. However, in other embodiments different current thresholds are used.

As best shown in FIG. 5, unit 105 includes a first electrical circuit (which includes the electrical components that are generally bounded by a rectangle 121) and unit 106 includes a second electrical circuit (which includes the electrical components that are generally bounded by two rectangles 122). These two circuits also included additional common electrical components which are generally represented by those components that are bounded by broken line 123. As shown in FIG. 5, these common components include primarily PIC 16F684 (both devices). That is, the shared components include the two processors that interact and cooperate to provide redundancy, allow for self-testing, and to enable other high-level functions for device 100. Importantly, the sharing of these components allows a cost-effective implementation for this additional functionality that could not be practically or economically realised from separate physical packaging or design of the two RCD and iFS functionalities.

Unit 112 includes a third circuit that, as shown in FIG. 5, generally includes the components bounded by rectangle 124.

As also shown by FIG. 3 and FIG. 5 in combination, device 100 is realised with unit 105 and unit 106 being defined by a single electrical circuit 125 which includes substantially all of the components in the abovementioned circuits. That is, this single circuit also includes the current limiter unit 107, and the protection unit 112. Moreover, the single circuit of FIG. 5 allows the embodiment to be fully realized (with the minor exception of the two differential transformers and the isolation switch 113) as a single electronic circuit and therefore as an integrated circuit to contribute to low cost and ultimate manufacturability. Alternative embodiments offering similar functionality use similar or parallel electronic techniques. In addition in further embodiments the differential transformers and switch (that is, the electrical isolator actuated by unit 112) are implemented using high voltage silicon, GAN, SiC and/or MEMS technology for certain (in particular low current low voltage) applications. That is, other embodiments are able to realizing a completely solid state implementation.

It will also be appreciated that the use of a single electrical circuit and single circuit board facilitates the containment of device 100 in a single housing. In this embodiments use is made of a standardised housing to further enhance the retrofitting of device 100 within an existing switchboard or other location within an ECS, while offering users with a familiar form factor.

As shown in FIGS. 3 and 4, circuit 125 (the single circuit) is electrically connected to the active conductor 4 and the neutral conductor 5 downstream of switch 113 via lines 129 and 130. This allows circuit 125 (and the various parts of that circuit, such as unit 106) to use those conductors as reference points.

In FIG. 5 the single circuit 125 is developed completely in silicon, with the exception of the transformers and the switch 113 (which are designated in FIGS. 5 as S1 and S2). However, in other embodiments these exceptions are also able to be implemented to allow full integration of all the components. A list of the electrical components used in circuit 125 is provided below in Appendix 1.

In use, unit 105 monitors the differential current flowing through terminals 2 and 3 to terminals 11 and 12 respectively (and therefore onto load 13). This current is measured through differential current transformer 115. If the differential signal exceeds a pre-selectable level—which would indicate an unacceptably high current is leaking from load 13 due to a fault—then unit 105 will issue the first fault signal. Unit 112 is responsive to that signal to cause the protection function to operate to disconnect load 13 from source 6. This occurs through the operation of switch 113 toggling to a protective state.

Unit 106 monitors the “iFS current”—that is, the current flowing from metalwork 102 to the power supply reference (normally supply neutral) through lines 129 and 130. If this current exceeds a pre-selectable level (indicating a fault of the power system to the metalwork 102) then unit 106 will generate the second fault signal. Unit 112 is responsive to the second fault signal to disconnect—that is, electrically isolate—load 13 by progressing switch 113 to a protective state.

In addition, current limit unit 107 provides a connection to allow current to flow from metalwork 102 to earth 110. In this way unit 112 monitors current flow from metalwork 102 to earth 110 through current transformer 116. If the current exceeds a predetermined threshold, unit 117 controls unit 107 to electrically isolate metalwork 102 from earth 110. In other embodiments the monitoring of the current between metalwork 102 and earth 110 occurs at unit 107.

It will be appreciated that contemporaneously to the control of unit 107 to isolate metalwork 102 from earth 110, unit 112 progresses switch 113 from the normal operational state to the protective state. That is, load 13 is then fully isolated from both the power source and earth 110.

In this embodiment the processors included in circuit 115 are programmed to implement a testing regime. This regime includes a self-test function for testing the operation of the circuitry used in circuit 125.

In a further embodiment of circuit 125 (not shown) use is made of alarms or alerts to indicate the state of operation of device 100, and in particular to indicate if one or more of the faults has been detected. These alarms or alerts are selected from: electrical communications; visual indications; and audible indications.

Further embodiments of the protection device (not shown) include remote monitoring functionality to allow the device to be monitored as part of a smart grid, as an SNMP node, or as an integrated node in another remote monitoring system (whether proprietary or otherwise).

FIG. 5 is provided is an illustration of an exemplary embodiment that is able to be implemented (other than for the two transformers and the isolation switches S1 and S2) as an electronic circuit 125 and therefore as an integrated circuit for minimal cost and ultimate manufacturability. Other embodiments having similar functionality and using similar or parallel electronic techniques by someone skilled in the art are also anticipated. In addition it is anticipated that in other embodiments the current transformers and switches S1 and S2 are able to be implemented using high voltage silicon, GAN or SiC and MEMS technology for certain (in particular low current low voltage) applications. That is, it is appreciated by the inventors that embodiments are able to be implemented using a completely solid state circuit.

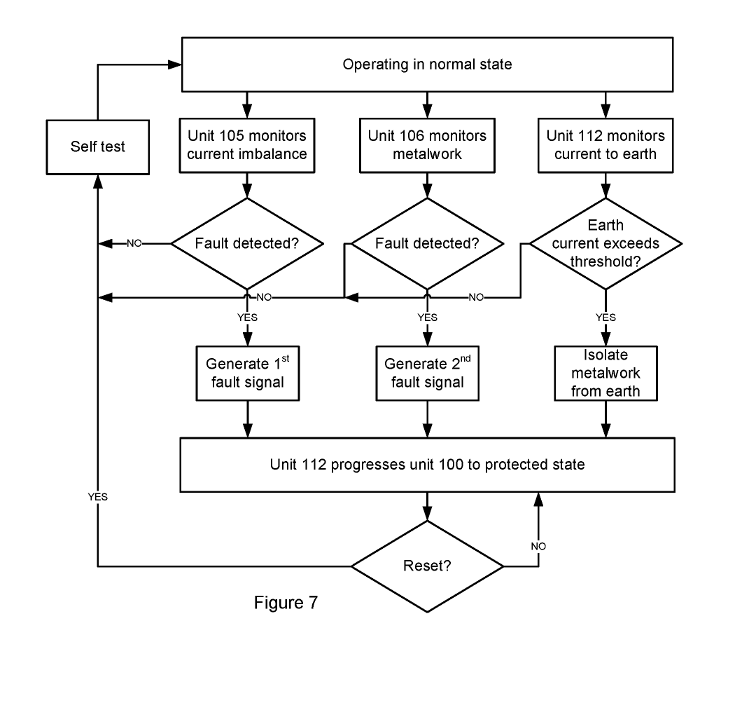

The operation of device 100 is illustrated in the flowchart of FIG. 7.

The major advantages provided by different embodiments include:
The use of a single circuit to provide multiple protection functions.
The inclusion of RCD functionality, iFS functionality and earth isolation functionality in a single device.
Applicability of the embodiments for use in any EDS. For example, some embodiments are able to be used in any EDS without modification any still provide protection.
The protection device is automatically configured to provide a high level of protection regardless of the type of the EDS.
Ability of the protection devices to adapt to changing EDS conditions with time. For example, if an installation initially has a good earth connection that deteriorates with time, the protection device will still operate to protect personnel and equipment.
The sharing of electrical components between the functionalities to allow a lower cost implementation without compromising the quality of the protection.
The ability to use high voltage Si, GAN, SIC or MEMS technology to implement a solid state embodiment of the invention, and to allow for integrated current transformers and/or circuit breakers.
The provision of self-testing and user testing functionality through the use of microprocessor control.

It will be appreciated that the disclosure above provides various significant electrical protection devices.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

APPENDIX 1

| Comment | Description | Designator | Footprint | LibRef | Quantity |
|---|---|---|---|---|---|
| D305 | Zener Diode | 10V | DIODE-0.7 | D Zener | 1 |
| | Capacitor | C1, C6, C8, C9, C11 | RAD-0.3 | CAP | 5 |
| 0603 | Capacitor | C2 | RAD-0.3 | CAP | 1 |
| Cap | Capacitor | C3, C10 | RAD-0.3 | CAP | 2 |
| 10 uF | | C5 | | CAP | 1 |
| 4.7 uF | | C7 | | CAP | 1 |
| 100 nF | Capacitor | C17, C18 | RAD-0.3 | CAP | 2 |
| 10 nF | Capacitor | C18 | RAD-0.3 | Cap | 2 |
| 10 uF | Capacitor | C18 | RAD-0.3 | Cap | 1 |
| 33 nF | Capacitor | C18 | RAD-0.3 | Cap | 1 |
| 33 nF 500 V | Capacitor | C18 | RAD-0.3 | Cap | 2 |
| 220 nF | Capacitor | C18 | RAD-0.3 | Cap | 2 |
| 1n4007 | | D1 | | D1 | 1 |
| Diode | Default | D2, D3, D4, D303, D306 | DSO-C2/X3.3 | Diode | 6 |
| | Diode | | | | |
| BAV99W | | D5, D8 | | D1, DIODE | 2 |
| | Default | D6 | DSO-C2/X3.3 | Diode | 1 |
| | Diode | | | | |
| BAS16W | | D7 | | D1 | 1 |
| BAV99W | Default | D9, D10 | DSO-C2/X3.3 | DIODE | 2 |
| | Diode | | | | |
| 10 V | Zener Diode | D300 | DIODE-0.7 | D Zener | 1 |
| BAS16 | Default | D301, D304, D310, D311, | DSO-C2/X3.3 | DIODE | 8 |
| | Diode | D500, D501, D? | | | |
| Solenoid Coil | Magnetic- | L1 | AXIAL-0.9 | Inductor Iron | 1 |
| | Core | | | | |
| | Inductor | | | | |
| | Adjustable | L2, L5, L7 | AXIAL-1.0 | Inductor Iron | 3 |
| | Magnetic- | | | Adj | |
| | Core | | | | |
| | Inductor | | | | |
| | Inductor | L3, L4, L6, L8 | INDC1005- | Inductor | 4 |
| | | | 0402 | | |
| 5BC856B | PNP | Q1 | BCY-W3/E4 | 2N3906 | 1 |
| | General | | | | |
| | Purpose | | | | |
| | Amplifier | | | | |
| BC857B | PNP | Q1 | BCY-W3/E4 | 2N3906 | 1 |
| | General | | | | |
| | Purpose | | | | |
| | Amplifier | | | | |
| BC846BW | NPN Bipolar | Q2, Q9 | BCY-W3 | npn | 2 |
| | Transistor | | | | |
| BC846B | NPN Bipolar | Q3 | BCY-W3 | npn | 1 |
| | Transistor | | | | |
| BC856BW | PNP | Q4 | BCY-W3/E4 | 2N3906 | 1 |
| | General | | | | |
| | Purpose | | | | |
| | Amplifier | | | | |
| RSE002P03TL | P-Channel | Q5 | BCY-W3/H.8 | MOSFET-P | 1 |
| | MOSFET | | | | |
| 2N7002W | N-Channel | Q6 | BCY-W3/H.8 | MOSFET-N | 1 |
| | MOSFET | | | | |
| FMMT560 | PNP Bipolar | Q7 | SO-G3/C2.5 | PNP | 1 |
| | Transistor | | | | |
| FMMT459 | NPN Bipolar | Q8 | BCY-W3 | NPN | 1 |
| | Transistor | | | | |
| BC856BW | PNP Bipolar | Q10 | SO-G3/C2.5 | PNP | 1 |
| | Transistor | | | | |
| PNP | PNP Bipolar | Q151, Q152, Q201, Q202, | SO-G3/C2.5 | PNP | 6 |
| | Transistor | Q305, Q310 | | | |
| NPN | NPN Bipolar | Q153, Q154, Q203, Q204, | BCY-W3 | NPN | 9 |
| | Transistor | Q303, Q304, Q306, Q311, | | | |
| | | Q? | | | |
| IGBT | N-Channel | Q301, Q302 | BCY-W3/B.8 | MOSFET-N | 2 |
| | MOSFET | | | | |
| BC847B | NPN Bipolar | Q? | BCY-W3 | NPN | 1 |
| | Transistor | | | | |
| BC857B | PNP Bipolar | Q? | SO-G3/C2.5 | PNP | 1 |
| | Transistor | | | | |
| 300k | Resistor | R1, R30 | AXIAL-0.3 | Res1 | 2 |
| | Resistor | R2, R7, R8, R9, R17, R18, | AXIAL-0.3 | Res1 | 10 |
| | | R27, R31, R34, R37 | | | |
| Res1 | Resistor | R3, R5, R12, R13, R14, | AXIAL-0.3 | Res1 | 13 |
| | | R16, R20, R25, R26, R28, | | | |
| | | R29, R36, R38 | | | |
| 60k | Resistor | R4, R24, R39 | AXIAL-0.3 | Res1 | 3 |
| 10R | Resistor | R6 | AXIAL-0.3 | Res1 | 1 |
| 1M | Resistor | R10, R32 | AXIAL-0.3 | RES1 | 2 |
| 5K | Resistor | R15, R35 | AXIAL-0.3 | RES1 | 2 |
| 2.1K | Resistor | R19 | AXIAL-0.3 | RES1 | 1 |
| 10k | Resistor | R21, R42, R43, R44, R72, | AXIAL-0.3 | Res1 | 7 |
| | | R87, R90 | | | |
| 1.6K | Resistor | R22 | AXIAL-0.3 | RES1 | 1 |
| 1K | Resistor | R23, R33 | AXIAL-0.3 | Res1 | 2 |
| 500R | Resistor | R40, R41 | AXIAL-0.3 | Res1 | 2 |
| 100k | Resistor | R45, R48, R49, R50, R59, | AXIAL-0.3 | Res1 | 21 |
| | | R60, R62, R63, R65, R74, | | | |
| | | R75, R76, R79, R83, R84, | | | |
| | | R88, R89, R95, R96, R99, | | | |
| | | R104 | | | |
| 100R | Resistor | R46 | AXIAL-0.3 | Res1 | 1 |
| 80R | Resistor | R47, R85, R86 | AXIAL-0.3 | Res1 | 3 |
| 10k | Resistor | R51, R61 | | RES | 2 |
| 400k | Resistor | R52, R55, R64, R68 | AXIAL-0.3 | Res1 | 4 |
| 200k | Resistor | R53, R54, R56, R66, R67, | AXIAL-0.3 | Res1 | 7 |
| | | R69, R100 | | | |
| 200R | Resistor | R57, R70, R71 | AXIAL-0.3 | Res1 | 3 |
| 200 | Resistor | R58 | AXIAL-0.3 | Res1 | 1 |
| 100ki | Resistor | R73 | AXIAL-0.3 | Res1 | 1 |
| 2k4 | Resistor | R77 | AXIAL-0.3 | Res1 | 1 |
| 25k | Resistor | R78 | AXIAL-0.3 | Res1 | 1 |
| 24k | Resistor | R80 | AXIAL-0.3 | Res1 | 1 |
| 600k | Resistor | R81 | AXIAL-0.3 | Res1 | 1 |
| 2M5 | Resistor | R82 | AXIAL-0.3 | Res1 | 1 |
| 20k | Resistor | R91, R93, R94 | AXIAL-0.3 | Res1 | 3 |
| 50k | Resistor | R92 | AXIAL-0.3 | Res1 | 1 |
| 500k | Resistor | R97, R101 | AXIAL-0.3 | Res1 | 2 |
| 2Meg | Resistor | R102, R103 | AXIAL-0.3 | Res1 | 2 |
| SW-SPST | Single-Pole, | S1 | SPST-2 | SW-SPST | 1 |
| | Single- | | | | |
| | Throw | | | | |
| | Switch | | | | |
| | Switch | S1, S2 | SPST-2 | SW-PB | 2 |
| Z0103 | Triac | T1, T2 | SFM-T3/A2.4V | TRIAC | 2 |
| TLC2252 | | U1 | DIP-8 | LF353 | 1 |
| TLC22524 | | U1 | DIP-8 | LF353 | 1 |
| PIC16F684 | | U1, U2 | DIP8 | PIC12F629 | 2 |
| TLC2254 | | U1B | DIP-8 | LF353 | 1 |
| Varistor | | V1 | CAPR2.54- | CAP | 1 |
| | | | 5.1X3.2 | | |
| Varistor | Capacitor | V2, V3 | RAD-0.3 | CAP | 2 |
| BZX84C43W | | Z1, Z2 | SOT23 | ZENER(SOT- | 2 |
| | | | | 23) | |
| 3V6 | | Z3, Z4 | SOT23 | ZENER(SOT- | 2 |
| | | | | 23) | |
| BZX84C12 | | Z5, Z6 | SOT23 | ZENER(SOT- | 2 |
| | | | | 23) | |
| 4V7 | | Z7, Z8 | SOT23 | ZENER(SOT- | 2 |
| | | | | 23) | |

1. An electrical protection device for an electrical load having an external conductive surface, the device including:
at least two input terminals for electrically connecting to an active conductor and a neutral conductor of an electrical power source that is upstream of the protection device;
at least two output terminals for electrically connecting to the load, wherein the load is electrically downstream of the protection device and, in use, draws a load current;
a first monitoring unit that is responsive to the load current flowing in the active conductor and the neutral conductor for selectively generating a first fault signal;
a second monitoring unit for selectively generating a second fault signal in response to either or both of: current flowing from the surface; and the voltage between the surface and the neutral conductor and/or the earth; and
a protection unit for operating in a normal state to electrically connect the input terminals to the output terminals to allow the load current to flow from the source to the load via the protection device, the protection unit being responsive to either of the first fault signal and the second fault signal for operating in a protected state to electrically isolate the input terminals from the output terminals and prevent the flow of the load current.

2. An electrical protection device according to claim 1 wherein the conductive surface is protective metalwork.

3. An electrical protection device according to claim 1 wherein the first monitoring unit is responsive to an imbalance in the load current flowing in the active and the neutral conductors for selectively generating the first fault signal.

4. An electrical protection device according to claim 1 wherein the second monitoring unit generates the second fault signal in response to the current flowing from the surface to the neutral conductor.

5. An electrical protection device according to claim 1 wherein the second monitoring unit generates the second fault signal in response to the current flowing from the surface to an earth.

6. An electrical protection device according to claim 1 wherein the second monitoring unit generates the second fault signal in response to the voltage between the surface and the neutral conductor.

7. An electrical protection device according to claim 1 wherein the second monitoring unit generates the second fault signal in response to the voltage between the surface and the earth.

8. An electrical protection device according to claim 1 including a current limiter unit between the surface and an electrical earth, the current limiter unit being responsive to current flowing from the surface to the earth for selectively electrically isolating the surface from the earth.

9. An electrical protection device according to claim 1 wherein the first monitoring unit includes a first electrical circuit and the second monitoring unit includes a second electrical circuit having at least one electrical component in common with the first electrical circuit.

10. An electrical protection circuit according to claim 9 wherein the first electrical circuit and the second electrical circuit have multiple electrical components in common.

11. An electrical protection device according to claim 9 wherein the at least one electrical component is a processor.

12. An electrical protection device according to claim 9 wherein the at least one electrical component is a pair of mirrored processors.

13. An electrical protection device according to claim 1 wherein the first monitoring unit and the second monitoring unit are defined by a single electrical circuit.

14. An electrical protection device according to claim 1 wherein two or more of the first monitoring unit, the second monitoring unit, and the protection unit are defined by a single electrical circuit.

15. An electrical protection device according to claim 14 wherein the single electrical circuit is contained within a single housing.

16. An electrical protection device according to claim 14 wherein the single electrical circuit is mounted to a single circuit board.

17. An electrical protection device according to claim 1 including a plurality of electrical components, wherein all of the electrical components are solid state components.

18. An electrical protection device according to claim 17 wherein the solid state components are included in one or more integrated circuits.

19. An electrical protection device according to claim 18 wherein the solid state components are included in a single integrated circuit.

20. An electrical protection device according to claim 1 including one or more processor.
